(19) United States
(12) Patent Application Publication
(10) Pub. No.: US 2026/0045434 A1
(43) Pub. Date: Feb. 12, 2026

(54) Electrical protection device, distribution assembly and associated electrical panel

(71) Applicant: Schneider Electric Industries SAS, Rueil Malmaison (FR)

(72) Inventor: Fabien CORONA, UCHIZY (FR)

(21) Appl. No.: 19/360,545

(22) Filed: Oct. 16, 2025

(30) Foreign Application Priority Data
Oct. 21, 2004 (FR) FR2411465

(51) Int. Cl. H01H 71/10; H01H 71/08; H02B 1/20

(52) U.S. Cl. CPC H01H 71/10; H01H 71/08; H02B 1/205

(57) ABSTRACT

This electrical protection device (300), configured to electrically connect an electrical load (M) to an electrical power source(S), comprises incoming terminals (302), outgoing terminals (304), and cut-off means (310) actuated by a bistable actuator (324). A microcontroller (320) is provided to generate a fault signal (S320), which triggers the actuator, and an output signal (S321), which is different from the fault signal. The protection device comprises a supervision circuit (500), which is interposed between the microcontroller (320) and the actuator (324) and includes an oscillator (510) configured to generate a periodic signal (S510). The supervision circuit is configured to generate a trigger signal (S324) when, alternatively, the output signal (S321) of the microcontroller (320) is absent, or the periodic signal (S510) of the oscillator (510) is absent, or when a fault signal (S320) is emitted.

### BACKGROUND

The present invention relates to an electrical protection device, a protection assembly comprising such an electrical protection device, and an electrical panel comprising such a protection device or such a protection assembly.

Protection devices comprising separable contacts, which are movable under the control of an actuator, are of interest here. Devices in which the actuator is monostable and comprises a no-voltage coil, that is to say that the coil needs to have a voltage applied to it in order to close the contacts, are known. When the voltage is interrupted, the contacts open naturally. In other words, the protection device is in an open configuration by default, that is to say that in the event of a malfunction, the protection device returns to the configuration which provides the most safety to users. However, such an actuator consumes energy continuously, generating heat, this not being desirable.

It is these problems that the invention more particularly intends to overcome by proposing a protection device that is energy-efficient while being safe.

### SUMMARY

To this end, the invention relates to an electrical protection device, configured to electrically connect an electrical load to an electrical power source, the protection device comprising:
at least two incoming terminals, which are configured to be electrically connected to a phase of the power source and possibly to a neutral of the power source,
outgoing terminals, which are configured to be connected to the electrical load, each outgoing terminal being associated with a respective incoming terminal,
power supply terminals, which are different from the incoming terminals and which are configured to be connected to a bus supplying operating electrical energy, the operating electrical energy possibly coming from the power source,
electromechanical cut-off means comprising separable contacts, which are movable, by means of an actuator, between a closed position, in which each incoming terminal is electrically connected to the associated outgoing terminal, the protection device being in a closed configuration, and an open position, in which the passage of an electric current between the incoming terminal and the associated outgoing terminal is prevented, the protection device being in an open configuration, the actuator being configured to cause the electromechanical cut-off means to transition from the closed position to the open position when the actuator receives a trigger signal,
detection means, which are configured to measure electrical quantities across the outgoing terminals and to detect at least one electrical fault,
a microcontroller, which is configured to generate a fault signal when the detection means detect a first electrical fault,
a first power supply unit, which is configured to receive electrical energy from the power supply bus and to supply operating electrical energy to the microcontroller,

wherein:
the actuator is a bistable actuator,
the protection device comprises:
   i. a supervision circuit, which is interposed between the microcontroller and the actuator, the supervision circuit including an oscillator configured to generate a periodic signal, and
   ii. a second power supply unit, which is different from the first power supply unit and is configured to receive electrical energy from the power supply bus and to supply electrical energy to the supervision circuit,
the microcontroller is configured to generate an output signal, which is different from the fault signal,
the supervision circuit encompasses:
   a first input gate, which is a logic gate configured to receive the output signal of the microcontroller,
   a second input gate, which is a logic gate configured to receive the periodic signal of the oscillator,
   a third input gate, which is a logic gate configured to receive the fault signal of the microcontroller,
   a main output gate, which is a logic gate connected to the actuator,
the supervision circuit being configured to generate a trigger signal via the main output gate when, alternatively:
   the first input gate does not receive the output signal of the microcontroller, or
   the second input gate does not receive the periodic signal of the oscillator, or.
   the third input gate receives a fault signal,
the supervision circuit is configured not to generate the trigger signal via the main output gate as long as, at the same time:
   the first input gate receives the output signal of the microcontroller, and
   the second input gate receives the periodic signal of the oscillator, and
   the third input gate receives no fault signal.

Owing to the invention, the presence of the supervision device offers active safety, that is to say forces the actuator to be triggered both in the event of a malfunction of the microcontroller and when the supervision device, in particular the oscillator, malfunctions. Numerous failure modes are thus covered. For example, when one of the power supply units fails, the actuator is triggered. When the microcontroller malfunctions, the actuator is triggered. When the supervision device malfunctions, the actuator is triggered. The bistable actuator, for its part, only consumes electrical energy when the bistable actuator switches from one position to the other. The bistable actuator is thus particularly energy-efficient and thus makes it possible to limit the heating of the protection device.

According to advantageous but non-mandatory aspects of the invention, such an electrical protection device may incorporate one or more of the following features, either alone or in any technically permissible combination:
The supervision circuit comprises:
   a first logic circuit, which encompasses the first input gate and the second input gate and implements an AND logic gate, the AND logic gate combining the output signal of the microcontroller with the periodic signal of the oscillator, so as to generate a control signal,
   a second logic circuit, which encompasses the third logic input and the main output gate, the second logic circuit implementing an OR logic gate, the OR logic gate combining the control signal of the AND logic gate with the fault signal of the microcontroller, so as to generate the trigger signal, which is transmitted from the main output gate to the actuator so as to cause the actuator to switch,

wherein:
the output signal is configured to cancel out the periodic signal, such that:
   when the oscillator generates the periodic signal and, at the same time, the microcontroller generates the output signal, then the control signal is a hold signal, designed to leave the actuator in the closed position,
   when the microcontroller no longer generates the output signal, the control signal is a trigger signal.
The microcontroller comprises a reception input for receiving the periodic signal of the oscillator, the microcontroller being configured to, when the periodic signal has not detected for a predetermined time interval, generate the fault signal.
The supervision circuit is realized by a software-free electronic circuit.
The oscillator is an NE555 integrated circuit or equivalent.

The invention also relates to a distribution assembly configured to distribute electrical energy from the power source to at least one electrical load, wherein the distribution assembly comprises a distribution device, which comprises:
a power bus, which comprises a plurality of busbars:
   which include at least one phase bar and possibly one neutral bar, the possible neutral bar being associated with the neutral of the power source, each phase bar being respectively associated with a phase of the power source,
   which extend parallel to each other along a main axis of the distribution device and are aligned along a height axis which is orthogonal to the main axis,
a power supply bus, which is separate from the power bus, the distribution assembly also comprises a copy of the protection device as described above, the protection device being mounted on the remainder of the distribution device such that:
each incoming terminal is electrically connected to a corresponding busbar,
the first power supply unit and the second power supply unit are electrically connected to the power supply bus.

According to advantageous but non-mandatory aspects of the invention, such a distribution device may incorporate one or more of the following features, either alone or in any technically permissible combination:
the distribution assembly further includes a main housing, which comprises:
   incoming terminals, which are configured to be connected to each phase and possibly to the neutral of the power source,
   outgoing terminals, which are each connected to the corresponding neutral or phase busbar, each outgoing terminal being associated with a respective busbar and with a respective incoming terminal,
   a power supply output, which is connected to the power supply bus, the main housing being configured to provide operating electrical energy to each cut-off device via the power supply bus.
The main housing comprises a general cut-off device, which is configured to, at the same time:
   electrically disconnect each outgoing terminal from the corresponding incoming terminal, and
   electrically disconnect the power supply output from the power source.
The general cut-off device exhibits monostable switch behaviour.

The invention also relates to an electrical panel comprising:
a box, delimiting an enclosure and having a bottom,
the distribution assembly as described above, wherein the distribution assembly is fixed to the bottom of the housing.

### BRIEF DESCRIPTION OF DRAWINGS

The invention will be better understood and other advantages thereof will become more clearly apparent in light of the following description of one embodiment of an electrical protection device, of a distribution assembly and of an electrical panel, according to the principle thereof, provided solely by way of example and given with reference to the appended drawings, in which:

FIG. 1 is a partially exploded perspective view of an electrical panel according to the invention, the electrical panel comprising a distribution assembly with at least one protection device, themselves also according to the invention;

FIG. 2 is a partially exploded perspective view of the distribution assembly of FIG. 1;

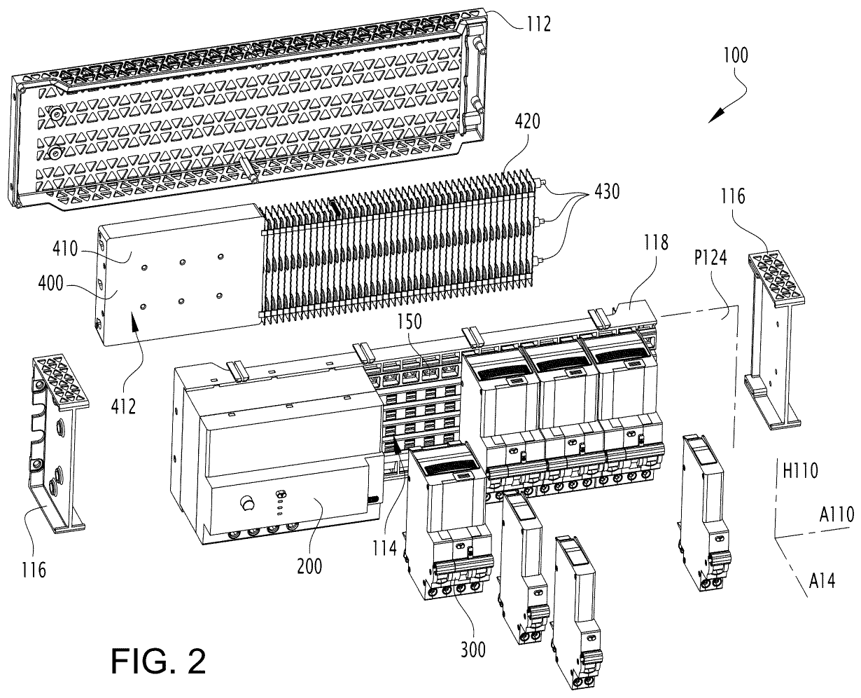

FIG. 3 respectively shows, on two inserts a) and b), a perspective view of the distribution assembly of FIG. 1, some parts being hidden, and a perspective view of a transfer bus of the distribution assembly;

FIG. 4 is a partially exploded perspective view of the distribution assembly of FIG. 1, some parts being hidden;

FIG. 5 is a schematic representation of the distribution assembly of FIG. 1;

FIG. 6 is a schematic representation of the protection device of FIG. 1;

FIG. 7 is a schematic representation of a first electronic circuit of the protection device of FIG. 1;

FIG. 8 is a schematic representation of a second electronic circuit of the protection device of FIG. 1; and

FIG. 9 is a schematic representation of a third electronic circuit of the protection device of FIG. 1.

### DETAILED DESCRIPTION

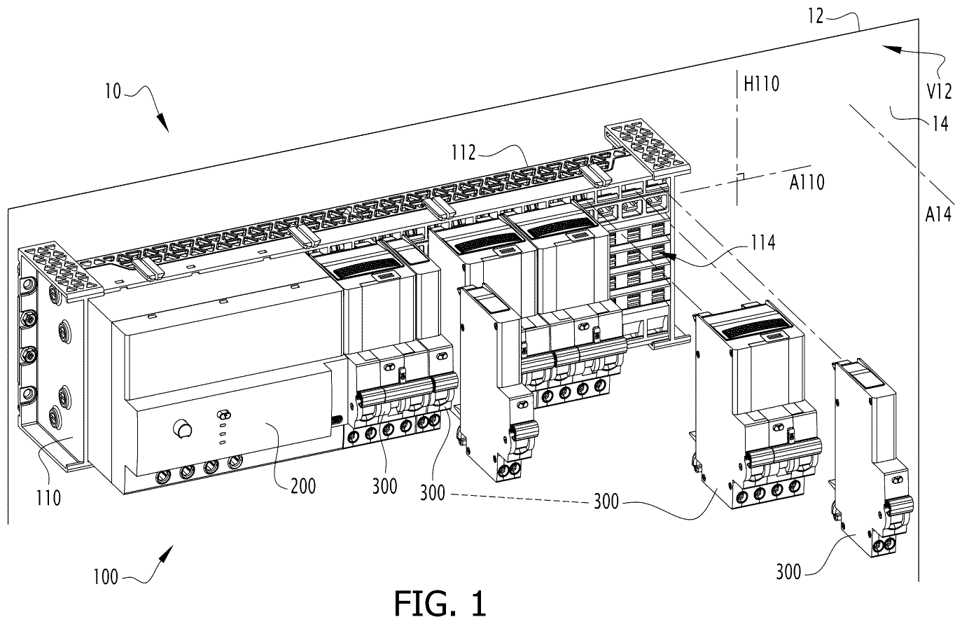

An electrical panel 10, according to the invention, is shown in FIG. 1. The electrical panel 10 comprises a box 12, which delimits an enclosure V12 and has a bottom 14. The bottom 14 is generally in a plane orthogonal to a depth axis A14. The enclosure V12 is advantageously closed by a door, which is not shown.

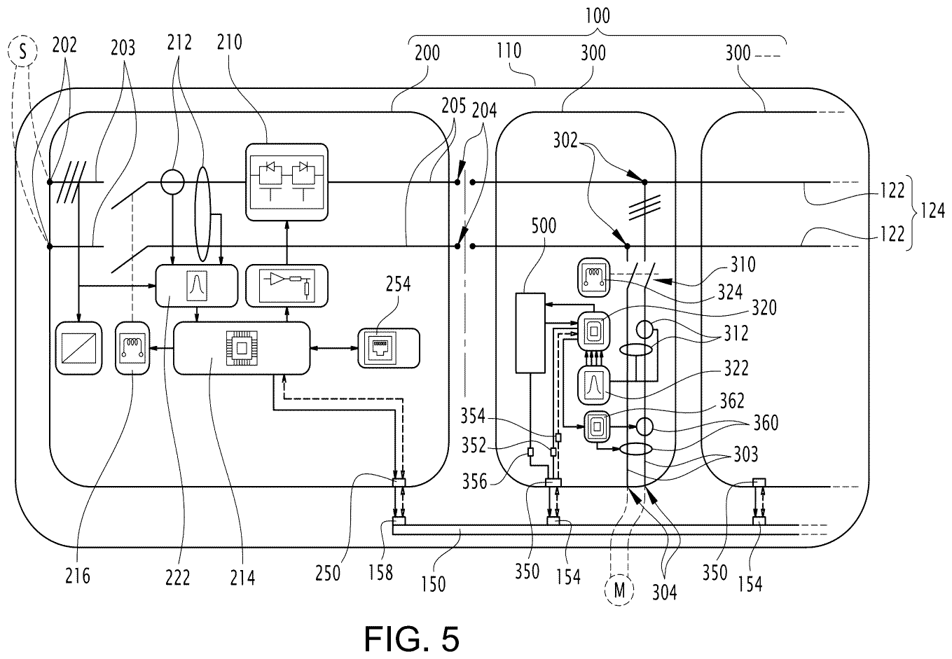

The electrical panel 10 comprises a distribution assembly 100. The distribution assembly 100 is fixed to the bottom 14 of the housing 12. 1. The distribution assembly 100 is configured to distribute electrical energy from a power source S to at least one electrical load M, for example a motor. The power source S and the electrical load M, which are shown schematically in FIG. 5, do not form part of the invention but are used to explain the operating context thereof. The power source S comprises a neutral and at least one phase. In the example illustrated, the power source S is a three-phase source, comprising a neutral and three phases. In a variant that is not shown, the power source S is single-phase, comprising a neutral and a single phase. According to another variant, the power source comprises three phases, and no neutral.

The distribution assembly 100 advantageously comprises a distribution device 110, by means of which the distribution assembly 100 is fixed to the bottom 14, a main housing 200, which is assembled to the distribution device 110, preferably in a reversible manner, and at least one protection device 300, here seven protection devices, each protection device 300 being assembled to the distribution device 110 in a reversible manner, in a mounted position of the protection device 300. The protection devices 300 here are outgoing housings, the principles of the invention being of course transposable to protection devices of a different type. It is thus possible to replace, if necessary, the main housing 200 in the event of a malfunction of the main housing 200, while retaining the other elements of the distribution assembly 100, distribution device 110 and outgoing housing(s) 300, this being economical. Similarly, it is possible to replace, if necessary, one or more of the protection devices 300, for example in the event of malfunction, while retaining the other elements, distribution device 110 and main housing 200, this being economical.

The distribution device 110 has an elongate shape, which extends along a main axis A110. When the distribution assembly 100 is in a normal operating configuration, the main axis A110 is parallel to the bottom 14, in other words orthogonal to the depth axis A14. Preferably, the main axis A110 is horizontal, as illustrated in FIG. 1. A height axis H110 is defined as an axis orthogonal both to the depth axis A14 and to the main axis A110. The description is given with reference to the orientation of the various elements as shown in the figures, in the knowledge that this may be different in reality.

In the example of FIG. 1, the main housing 200 is located on the left of the distribution assembly 100, the protection devices 300 being located on the right of the main housing 200.

When the distribution assembly 100 is fixed to the bottom 14, a rear portion 112 of the distribution device 110 is oriented facing the bottom 14, in other words oriented towards a rear direction of the distribution assembly 100. The rear direction is thus parallel to the depth axis A14. A front direction is also defined as being a direction opposite to the rear direction.

The distribution device 110 thus has a mounting face 114, which is generally oriented towards the front and is provided for mounting the main housing 200 and each protection device 300.

The rear portion 112 is made of an electrically insulating material, for example a synthetic polymer. The rear portion 112 here has a generally rectangular shape, which extends in its largest dimension parallel to the main axis A110. The small sides of the rectangle are thus parallel to the height axis H110. The distribution device 110 here comprises two flanges 116, which are made of an electrically insulating material. The two flanges 116 are assembled to the small sides of the rear portion 112 so as to form a basket.

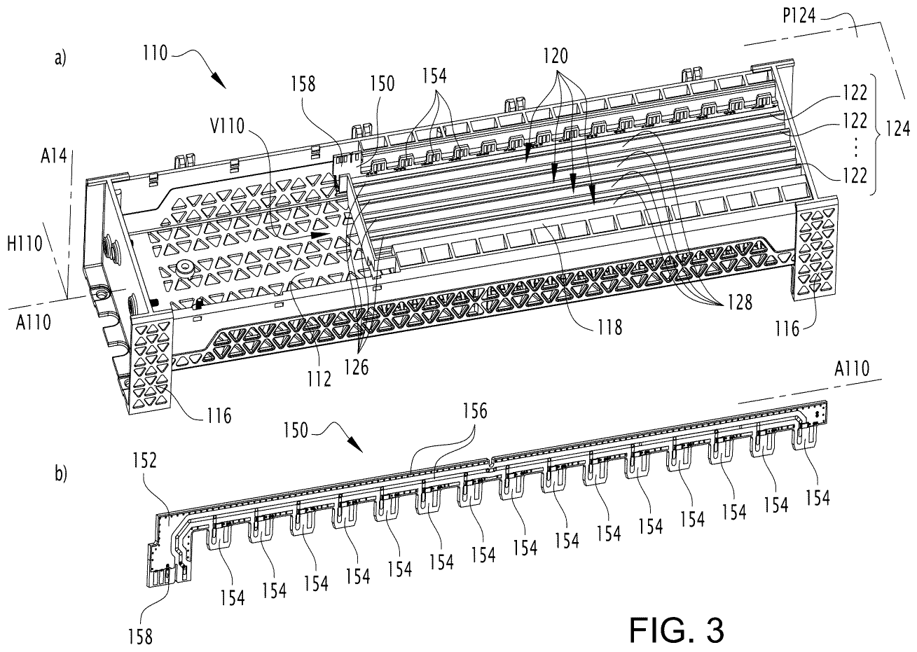

The distribution device 110 here comprises an insulating wall 118, which is made of an electrically insulating material and is assembled to the rear portion 112 and to the flanges 116, so as to form a cavity V110, as illustrated in FIG. 3.

In the example illustrated, the distribution device 110 advantageously comprises a cooling device 400, which is received in the cavity V110 and is provided to remove part of the heat generated by the main housing 200 when the distribution assembly 100 is in operation. The cooling device 400 is thus located on a rear side of the insulating wall 118, while on a front side of the insulating wall 118, the front side being oriented opposite to the rear side, the insulating wall 118 encompasses grooves 120 provided to receive a plurality of busbars 122, here four busbars 122. The busbars 122 together form a power bus 124 of the distribution device 110 and, by extension, of the distribution assembly 100. The distribution device 110 is thus a power distribution device 110.

The busbars 122 extend parallel to each other along the main axis A110 of the distribution assembly 100 and are aligned along the height axis H110. The busbars 122 together define a connection plane P124, which is a plane orthogonal to the depth axis A14, in other words parallel to the height axis H110 and to the main axis A110. The mounting face 114 is generally parallel to the connection plane P124.

The cooling device 400 comprises a contact plate 410, which is provided to capture part of the heat released by the main housing 200, a radiator 420, which is provided to dissipate the heat into the ambient air, and at least one heat pipe 430, here three heat pipes, which connects the contact plate 410 to the radiator 420 and is configured to transfer part of the heat captured by the contact plate 410 to the radiator 420.

The contact plate 410 here has a parallelepiped shape and has a contact face 412, which extends parallel to the connection plane P124. The contact face 412 is configured to cooperate, in particular via complementarity of shapes, with a rear face 230 of the main housing 200 in the configuration mounted on the distribution device 110, so as to promote heat transfer between the contact plate 410 and the main housing 200.

The busbars 122 include at least one phase bar and, possibly, a neutral bar, the neutral bar being associated with the neutral of the power source S, each phase bar being associated with a respective phase of the power source S. In the example illustrated, the power bus 124 comprises four busbars 122, the power source S being a three-phase source with a neutral. The distribution assembly 100 here has a so-called “3P+N”, or simply 3PN, configuration.

In a variant that is not shown, the power source S is three-phase, with or without neutral, while the distribution assembly does not comprise a busbar associated with the neutral. In other words, the distribution assembly comprises only three phase bars, each associated with a respective phase of the power source S. The distribution assembly is then in a so-called 3P configuration.

The principles of the invention are transposable regardless of the number of phases of the power source S. According to another variant that is not illustrated, the power source S is single-phase, that is to say comprises only the neutral and a single phase. The busbars 122 then include a single phase bar and the neutral bar. The distribution assembly is then in a so-called P+N, or simply PN, configuration. Regardless of the configurations, there are always a plurality of busbars 122, which include at least one phase bar, and possibly a neutral bar.

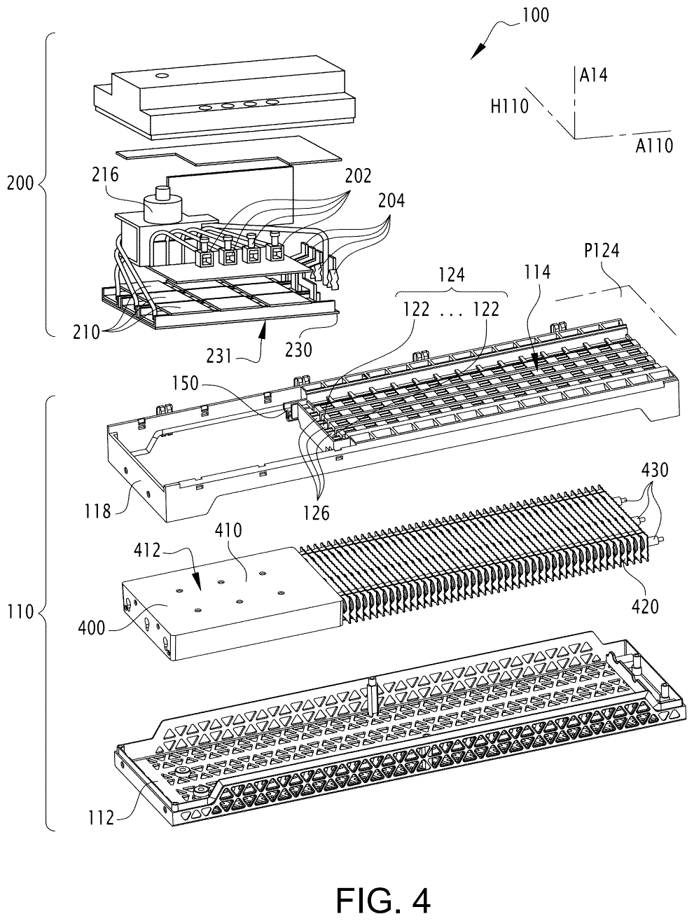

The main housing 200 will now be described, in particular with reference to FIGS. 4 and 5. In FIG. 5, the circuit of a single phase is shown, the three phases being shown, according to a known convention, by three parallel lines across the circuit.

The main housing 200 comprises incoming terminals 202, which are configured to be connected to the neutral and to each phase of the power source S, and outgoing terminals 204, which are configured to be connected to the busbars 122, each outgoing terminal being associated with a respective busbar and with a respective incoming terminal. The incoming terminals 202 here are screw terminals. Advantageously, the outgoing terminals 204 are connection clamps, which are each provided for reversible connection to a respective busbar 122, according to a connection movement oriented towards the rear of the distribution assembly 100. Thus, during the connection movement of the outgoing terminals 204 to the busbars 122, the rear face of the main housing 200 comes to bear against the contact face 412.

For each incoming terminal 202, the main housing comprises a corresponding incoming line 203, which is connected to the corresponding incoming terminal 202, and an outgoing line 205, which is connected to the associated outgoing terminal 204.

The main housing 200 comprises main cut-off means 210, which are switchable between a conductive configuration, in which each incoming terminal 202 associated with a phase of the power source S is electrically connected to the associated outgoing terminal 204, the main housing 200 being in a conductive configuration, and a cut-off configuration, in which the passage of an electric current between the incoming terminal 202 and the associated outgoing terminal 204 is prevented, the main housing 200 being in a cut-off configuration.

In the preferred example illustrated, the main cut-off means 210 are static cut-off means, that is to say power switches based on semiconductor components, preferably insulated-gate field-effect transistors, called JFETs or MOSFETs, and are thus referred to as “static” as opposed to cut-off means with a moving contact. The static cut-off means 210 are connected in series between the incoming line 203 and the associated outgoing line 205. The static cut-off means 210 are shown schematically in FIGS. 4 and 5. In a variant that is not shown, the main cut-off means 210 are electromechanical cut-off means with separable contacts.

During operation, the cut-off means 210 release heat, of the order of a few tens of Watts. The cut-off means 210 are advantageously disposed so as to promote the transfer of at least part of the released heat to the cooling device 400.

In particular, the cut-off means 210 are advantageously arranged against a rear wall 231 of the main housing 200, preferably in surface contact against the rear wall 231. The rear wall 231 is for example present when the main housing 200 is removable from the contact plate 410. The rear wall 231 encompasses the rear face 230, the rear face 230 being oriented opposite the cut-off means 210. The rear wall 231 is thus interposed between the cut-off means 210 and the contact plate 410 when the main housing 200 is mounted on the distribution device 110, such that part of the heat generated by the cut-off means 210 during operation is transferred to the contact plate 410 through the rear wall.

The main housing 200 comprises main detection means 212, which are configured to measure electrical quantities across the outgoing terminals and to detect an electrical fault on the basis of the measured values. The main detection means 212 are shown schematically here by measurement loops, which are arranged here on the outgoing lines 205. The schematic representation of the main detection means does not limit the type of electrical faults that the main detection means 212 are capable of detecting.

The main housing 200 is configured to transition from the conductive configuration to the cut-off configuration when the main detection means 212 detect a first electrical fault, for example a residual-current fault or a short-circuit fault.

The main housing 200 comprises a control unit 214, or ECU standing for Electronic Control Unit, which is configured to control the static cut-off means 210, in other words to cause the static cut-off means 210 to switch between the conductive configuration and the cut-off configuration. The control unit 214 is also configured to analyse the values measured by the main detection means 212 and to determine, on the basis of predefined criteria corresponding to a predetermined type of electrical fault, the presence of an electrical fault of the predetermined type. In FIG. 5, the use of predefined criteria is shown schematically by the presence of a so-called “primary” filter 222, the primary filter 222 being interposed between the main detection means 212 and the control unit 214.

Thus, the main detection means 212 are configured to detect electrical faults of short-circuit type. For example, the main detection means 212 include current sensors, in particular one current sensor per phase, while the control unit 214 is configured to analyse the measurements made by the current sensors and to detect a short circuit.

Preferably, the main detection means 212 also include a residual-current detection device. There are several types of residual-current faults, which are defined in particular in the IEC 60755:2017 standard. In particular, the types of electrical faults include the fact that the electrical signal is rectified, that the signal includes a high-frequency component, the rating—for example 30 mA or 300 mA—, etc. It is understood that the primary filter 222 defines criteria for detection of electrical faults by the control unit 214 of the main housing 200. Preferably, the primary filter 222 defines criteria for detecting a type of predetermined residual-current fault, the predetermined residual-current fault being chosen from amongst the faults defined in the IEC 60755:2017 standard.

Preferably, the main housing 200 also comprises, for each incoming terminal 202, a general cut-off device 216, which is a cut-off device with separable contacts, here a disconnector. The general cut-off device 216 is controlled by the electronic control unit 214 and allows the power source S to be electrically disconnected from the distribution assembly 100, for example in the event of a malfunction of the static cut-off means 210. The general cut-off device 216 is interposed between each incoming terminal 202 and the static cut-off means 210. Preferably, the general cut-off device 216 comprises a monostable switch, that is to say that the electronic control unit 214 must permanently electrify the general cut-off device 216 in order for the electrical connection to the power source to be maintained. In a variant, the general cut-off device 216 comprises a bistable switch, which is controlled by a circuit such that the general cut-off device 216 opens in the event of a loss of energy, this amounting to monostable behaviour. More generally, the general cut-off device 216 exhibits monostable switch behaviour.

Advantageously, the distribution device 110, and by extension the distribution assembly 100, also comprises a transfer bus 150. The transfer bus 150, which is shown in isolation in FIG. 3 b), is provided for operation to supply energy to each protection device 300 in the mounted position, that is to say connected to the busbars 122. The transfer bus 150 here is therefore an energy transfer bus, in other words a power supply bus, which is separate from the power bus 124. According to one illustrative example, the transfer bus 150 operates at a voltage of a few tens of volts, for example 50 V DC, while the power bus 124 operates at a voltage of 400 V three-phase AC. The transfer bus 150 here is a separate part, which is assembled to the remainder of the distribution device 110.

The transfer bus 150 comprises a body 152, which is made of an electrically insulating material, which has an elongate shape extending along the power bus 124. Thus, the transfer bus 150 extends along the main axis A110.

The transfer bus 150 defines a plurality of mounting areas 154, which are provided to be connected to each protection device in the mounted position, the mounting areas 154 being distributed, preferably regularly, along the main axis A110 and each being associated with a unique position along mounting areas 154, which are spaced apart from each other by a pitch of 18 mm here. Other pitches are of course possible. In a variant that is not shown, the mounting areas 154 are spaced apart from each other by a pitch of 9 mm.

The transfer bus 150 comprises at least two transfer lines 156, which extend along the body 152 and are configured to be electrically connected to each protection device 300 in the mounted position. The transfer lines 156 therefore comprise power supply lines.

The transfer bus 150 also comprises a connection area 158, which is provided for the connection of the main housing 200 in the mounted position on the distribution device 110. For example, the main housing 200 comprises a complementary terminal block 250, which is configured to cooperate with the connection area 158, such that the main housing is electrically connected to the transfer lines 156. In the preferred example illustrated, the main housing 200 draws the electrical energy necessary to supply power to the transfer bus 150 on the neutral and the phases of the power source S, between the static cut-off means 210 and the general cut-off device 216, the electrical energy thus supplied being available to the protection devices 300 for their operation, as described below. The complementary terminal block 250 here is an example of a power supply output of the main housing 200.

The transfer bus 150 here is realized by a printed circuit board, the transfer lines 156 being conductive tracks formed on the surface of the board, while the mounting areas 154 and the connection area 158 are tabs formed in the substrate of the board. In the example illustrated, the transfer bus 150 advantageously integrates a communication bus between the main housing 200 and each protection device 300.

The protection devices 300 will now be described.

Each protection device 300 thus comprises an incoming terminal block which is reversibly connectable to the busbars 122 and which comprises at least two incoming terminals 302, each incoming terminal 302 being configured to be electrically connected to a respective busbar 122. For each protection device 300, the incoming terminals 302 include a neutral incoming terminal, which is configured to be electrically connected to the neutral bar, and between one and three other incoming terminals, which are each configured to be connected to a respective phase bar. Each protection device 300 is configured to be reversibly mounted on the power bus 124, such that each incoming terminal 302 is electrically connected to the corresponding busbar 122.

Each protection device 300 also comprises an outgoing terminal block, which is configured to be connected to a respective electrical load M and which comprises outgoing terminals 304, each outgoing terminal 304 being respectively associated with a respective incoming terminal 302 and being connected to this incoming terminal 302 via a conduction path 303. The outgoing terminals 304 are shown schematically in FIG. 5.

In the non-limiting example illustrated, the protection devices 300 have different widths, the width being measured along the main axis A110. Thus, the protection devices 300 here are divided into two sub-groups, which correspond to two different widths, with thin protection devices 300 and wide protection devices 300, which are substantially three times wider than the thin protection devices 300. Other widths of protection devices 300 are of course conceivable. The width of the protection devices 300 is preferably a multiple of the pitch between each mounting area 154 of the transfer bus 150, i.e. 18 mm here. In a variant that is not shown, the protection devices 300 have a width equal to a multiple of 9 mm.

In the example illustrated, a protection device 300 configured to supply power to a single-phase electrical load advantageously has a width of 18 mm, while a protection device 300 configured to supply power to a three-phase electrical load has a width of three times 18 mm, i.e. 54 mm.

The thinnest protection devices 300 are configured to be connected to two busbars 122, including a neutral bar and a phase bar, while the widest protection devices 300 are configured to be connected to four busbars 122. The principles of the invention are applicable regardless of the number of phases to which each of the protection devices 300 is connected.

Preferably, the distribution device 110 is provided to receive five protection devices 300, which each comprise four incoming terminals, in other words five wide protection devices 300. According to an example that is not illustrated, the distribution assembly 100 comprises five protection devices 300, which each comprise four incoming terminals 302. As a corollary, the distribution device 110 is also provided to receive fifteen thin protection devices 300 each comprising two incoming terminals 302.

The busbars 122 each comprise:
a power supply portion 126, which is configured to be connected to an associated outgoing terminal 204 of the main housing 200 in a mounted configuration of the main housing, and
a connection portion 128, which extends on the same side of the power supply portion 126. The connection portions 128 are geometrically located on a front side of the connection plane P124 and together define a connection area of the power bus 124.

In FIG. 4, only the power supply portions 126 of the busbars 122 are visible, the connection portions 128 being hidden. The connection area is configured to receive at least one protection device 300, such that the protection device is connected to the power bus 124. The protection device 300 is then able to be connected to an electrical load, so as to supply electrical power to the electrical load.

Each protection device 300 comprises cut-off means 310, which are interposed between each incoming terminal 302 and the corresponding outgoing terminal 304. The cut-off means 310 are configured to switch between an armed configuration, in which each incoming terminal is electrically connected to the associated outgoing terminal, and a triggered configuration, in which the incoming terminal is electrically isolated from the associated outgoing terminal. The cut-off means 310 here are formed by an electromechanical mechanism with separable contacts. The armed configuration of the cut-off means 310 here therefore corresponds to a closed position of the moving contacts, the protection device 300 in question being in a closed configuration, while the triggered configuration of the cut-off means 310 corresponds to an open position of the separable contacts, the protection device 300 in question being in an open configuration. In a variant that is not shown, the cut-off means 310 of the protection device 300 are static cut-off means.

Each protection device 300 comprises secondary detection means 312, which are configured to measure electrical quantities across the corresponding outgoing terminals and to detect at least one electrical fault of a predetermined type, that is to say corresponding to predetermined detection criteria. In particular, the secondary detection means 312 are configured to measure an electric current flowing through each conduction path 303. The secondary detection means 312 are shown schematically here by measurement loops, which are arranged on the conduction paths 303 connecting the incoming terminals 302 to the outgoing terminals 304 here. The schematic representation of the secondary detection means 312 does not limit the type of electrical faults that the secondary detection means are capable of detecting. Thus, the secondary detection means 312 are configured to detect electrical faults of residual-current type and, optionally, of short-circuit type.

For example, the secondary detection means 312 include current sensors, in particular one current sensor per phase, while the protection device 300 comprises a microcontroller 320, which receives the measurements from the current sensors and is capable of determining whether the one or more measured currents exceed a short-circuit threshold.

The microcontroller 320 is supplied with power via the transfer bus 150. To this end, each protection device 300 comprises a transfer terminal block 350, which comprises power supply terminals 351, the transfer terminal block 350 being configured to be connected to the transfer bus 150 such that each transfer terminal is electrically connected to a respective transfer line 156. The transfer terminal block 350 here is therefore a power supply terminal block.

The power supply terminals 351 are different from the incoming terminals 302 or the outgoing terminals 304. The protection device 300 advantageously comprises a first power supply unit 352, also abbreviated to PSU, which is configured to receive electrical energy from the transfer bus 150, in particular from transfer lines 156 dedicated to supplying operating energy, and to supply operating electrical energy to the microcontroller 320. By extension, the first power supply unit 352 is also configured to supply operating energy to the secondary detection means 312. Operating electrical energy possibly comes from the power source.

Advantageously, the transfer bus 150 is also used to transfer data between each microcontroller 320 and the control unit 214 of the main housing 200. For example, the transfer of information passes through the same transfer lines 156 used for the transfer of energy. As an alternative that is not shown, the transfer bus 150 comprises specific information transfer lines, different from the transfer lines 156 being used for the power supply. The information transfer lines are preferentially formed on the transfer bus 150.

The protection device 300 advantageously comprises communication means 354, which are configured to receive information coming from a device that is remote from the protection device 300. In the example illustrated, the communication means 354 are separate from the microcontroller 320. In a variant that is not illustrated, the communication means 354 are integrated into the microcontroller 320.

The communication means 354 are advantageously configured to receive information via the transfer terminal block 350 and the transfer bus 150. In the preferred example illustrated, the protection device 300 is configured to receive information coming from the main housing 200, which constitutes a first example of a remote device. In the example illustrated, the main housing 200 comprises main communication means 254, which are represented here by a socket in the RJ45 format and which are provided so that a user is able to configure the main housing 200 and, more generally, the distribution assembly 100. According to one advantageous example of use, for each type of electrical load connected to the outgoing terminals 304, the configuration of the protection device 300 is adapted accordingly, so as to offer the most suitable protection against residual-current faults.

In a variant that is not illustrated, the communication means 354 comprise a connection socket, for example a socket in the RJ45 format, for receiving information. In this case, the information does not pass via the transfer bus 150. According to another variant that is not illustrated, the communication means 354 and/or the main communication means 254 are wireless means.

In the example illustrated, the protection device 300 advantageously comprises a supervision circuit 500 and a second power supply unit 356. The supervision circuit 500 is provided to supervise the correct operation of the microcontroller 320. The second power supply unit 356 is different from the first power supply unit 352 and is provided to receive electrical energy from the transfer bus 150 and to supply operating energy to the supervision circuit 500.

The use of two separate power supply units makes it possible to have power supply redundancy. In a variant that is not illustrated, the second power supply unit 356 is combined differently with the first power supply unit 352 in one redundant power supply unit.

The secondary detection means 312 include a residual-current detection device, for example a measurement loop, configured to measure a residual current. The microcontroller 320 is thus configured to evaluate the residual-current measurement using a detection filter 322, the detection filter 322 being previously recorded in a memory of the microcontroller 320 of the protection device 300 and being adapted for the detection of a residual-current fault of a first type.

It is understood that the secondary filter 322 defines the criteria for detecting electrical faults detected by the microcontroller 320 of the protection device 300. A specific secondary filter 322 therefore corresponds to each type of electrical fault given. Preferably, the secondary filter 322 defines criteria for detecting a predetermined residual-current fault type, which is chosen from amongst the faults defined in the IEC 60755:2017 standard.

Each microcontroller 320 is supplied with electrical operating energy via the transfer bus 150, independently of the configuration, armed or triggered, of the cut-off means 310.

Each protection device 300 here comprises an actuator 324, which is configured to move the electromechanical cut-off means 310 into the open position when the actuator 324 receives a trigger signal S324. In the context of the invention, the supervision circuit 500 is interposed between the microcontroller 320 and the actuator 324, the supervision circuit 500 being configured to generate the trigger signal in particular when the microcontroller 320 detects an electrical fault, in particular a short-circuit fault or a residual-current fault. In general, the microcontroller 320 is configured to generate a fault signal S320 when the secondary detection means 312 detect a first electrical fault, the fault signal S320 being received by the supervision circuit 500, which generates the trigger signal S324. Each protection device 300 is configured to transition from the closed configuration to the open configuration when the secondary detection means 312—and by extension the microcontroller 320—detect an electrical fault.

The microcontroller 320 is configured to generate an output signal S321, which is different from the fault signal S320 and is a signal intended for the supervision circuit 500, the output signal S321 being an indicator that the microcontroller 320 is operating as expected, in particular that the microcontroller 320 is well supplied with operating energy from the first power supply unit 352. The output signal S321 is a non-zero signal, which is advantageously sent periodically or continuously.

In the context of the present invention, the actuator 324 is a bistable actuator, that is to say that as long as the actuator 324 does not receive any trigger signal, the actuator 324 does not consume electrical energy and does not tend to move the electromechanical cut-off means 310. In other words, when the electromechanical cut-off means 310 are in the closed configuration, as long as the actuator 324 does not receive the trigger signal S324, the electromechanical cut-off means 310 remain in the closed configuration, and this without the actuator 324 consuming electrical energy.

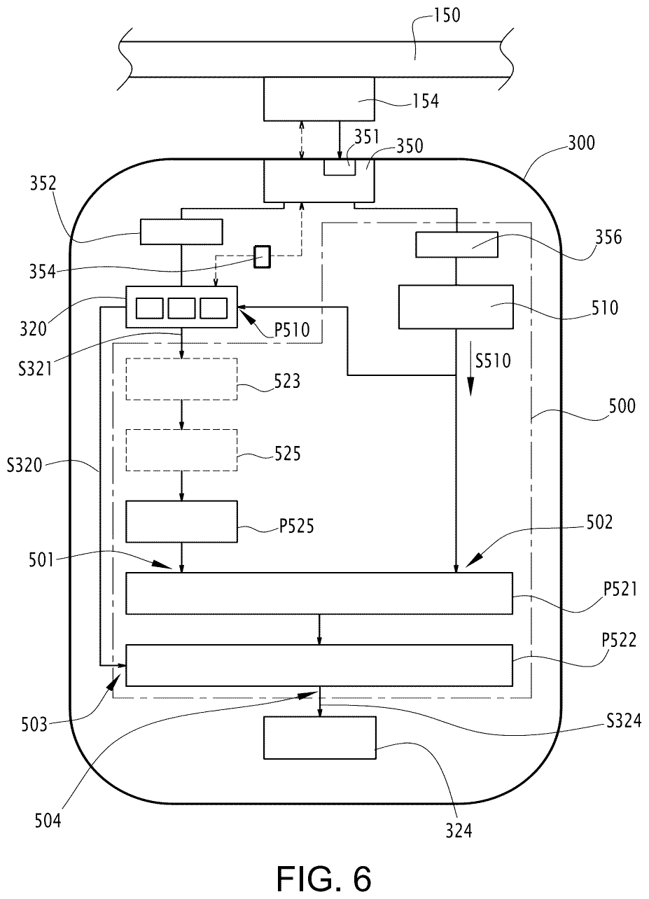

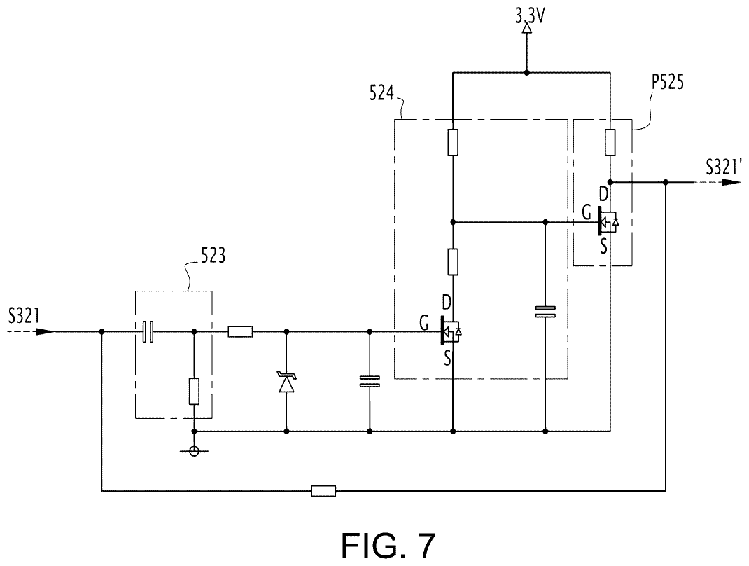

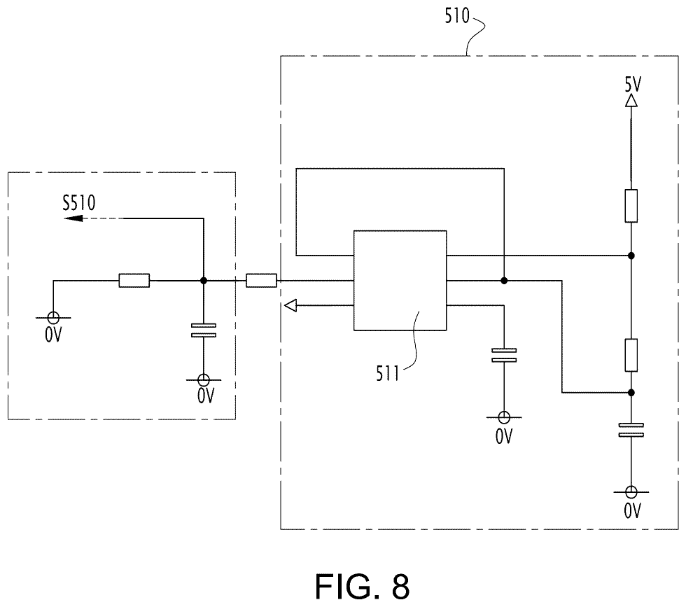

The supervision circuit 500 will now be described in detail with reference to FIGS. 6 to 9.

The supervision circuit 500 includes an oscillator 510, which is configured to generate a non-zero periodic signal S510. The oscillator 510 is thus supplied with electrical energy via the second power supply unit 356. Preferably, the oscillator 510 is supplied with electrical energy exclusively via the second power supply unit 356. It is understood that in the event of a malfunction of the second power supply unit 356, no periodic signal is generated. Preferably, the oscillator 510 is realized by means of an electronic circuit comprising only passive components. Passive components are understood to be components such as resistors, capacitors, inductors, transistors, etc. which do not comprise a microprocessor interpreting a control code. The risks of malfunction associated with coding errors are thus avoided. More generally, the supervision circuit 500 is advantageously a software-free electronic circuit. Preferably, the oscillator 510 is an integrated circuit 511 of the NE555 type or equivalent, which is both reliable and compact.

The supervision circuit 500 encompasses:
a first input gate 501, which is a logic gate configured to receive the output signal of the microcontroller 320,
a second input gate 502, which is a logic gate configured to receive the periodic signal of the oscillator 510,
a third input gate 503, which is a logic gate configured to receive the fault signal S320 of the microcontroller 320, and
a main output gate 504, which is a logic gate connected to the actuator 324.

The supervision circuit 500 is configured to generate a trigger signal S324 via the main output gate 504 when, alternatively:
the first input gate 501 does not receive the output signal S321 of the microcontroller 320, or
the second input gate 502 does not receive the periodic signal S510 of the oscillator 510, or
the third input gate 503 receives a fault signal S320.

The supervision circuit is configured not to generate the trigger signal S324 via the main output gate 504 as long as, at the same time:
the first input gate 501 receives the output signal S321 of the microcontroller 320, and
the second input gate 502 receives the periodic signal S510 of the oscillator 510, and
the third input gate 503 receives no fault signal S320 coming from the microcontroller 320.

It is understood that when the first power supply unit 352 fails, the microcontroller 320 no longer generates the output signal S321, causing the supervision circuit 500 to generate the trigger signal S324. The actuator 324 thus causes the electromechanical cut-off means 310 to move into the open position. In the example illustrated, the actuator 324 comprises two terminals CN1 and CN2, to which the second circuit 522 is connected. When the second power supply unit 356 fails, the oscillator 510 no longer generates the periodic signal S510, causing the supervision circuit 500 to generate the trigger signal S324.

According to one advantageous exemplary embodiment, the supervision circuit 500 comprises a first logic circuit 521, which comprises the first input gate 501 and the second input gate 502 and which implements a first logic gate P521 of “AND” type. The first logic gate P521 is also referred to as an “AND” gate. The first logic gate P521 combines the output signal S321 of the microcontroller 320 with the periodic signal S510 of the oscillator 510, so as to generate a control signal S521.

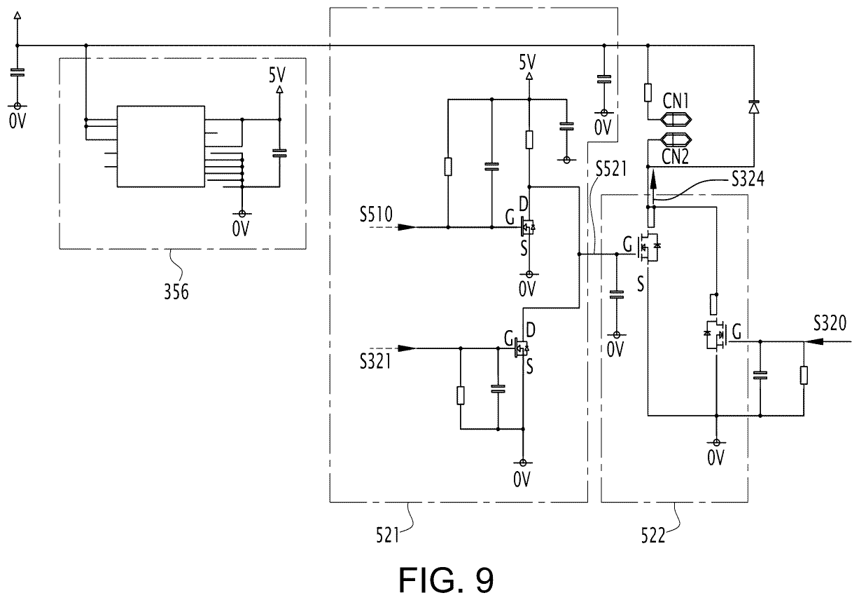

One exemplary embodiment of the first logic circuit 521 is shown in FIG. 9. Other arrangements of the components, or even other equivalent circuits, are of course possible for implementing the first logic gate P521 of “AND” type.

The supervision circuit 500 comprises a second logic circuit 522, which encompasses the third logic input 503 and the main output gate 504. The second logic circuit 522 implements a second logic gate of “OR” type and referenced P522, the second OR logic gate P522 combining the control signal S521 of the first AND logic gate P521 with the fault signal S320 of the microcontroller 320, so as to generate the trigger signal S324, which is transmitted from the main output gate 504 to the actuator 324 so as to cause the actuator 324 to switch. Advantageously, the second logic circuit 522 is supplied with power by an energy source that is independent of the first power supply unit 352 and of the second power supply unit 356. For example, the second logic circuit 522 is connected to the power supply terminals 351.

Similarly, the first logic circuit 521 is advantageously supplied with power by an energy source that is independent of the first power supply unit 352 and of the second power supply unit 356. For example, the first logic circuit 521 is connected to the power supply terminals 351.

The output signal S321 is configured to cancel out the periodic signal S510, such that:
when the oscillator 510 generates the periodic signal S510 and when, at the same time, the microcontroller 320 generates the output signal S321, then the control signal S521 generated by the first logic gate P521 is a hold signal which, in the absence of a fault signal S320, tends to leave the actuator 324 in the closed position after combination by the second logic gate P522,
when the microcontroller 320 no longer generates the output signal S320, the control signal S521 is a trigger signal. More precisely, in the absence of the output signal S321, the control signal S521 generated by the first AND logic gate P521 becomes, after passing through the second OR logic gate P522, a trigger signal S324.

In other words, the output signal S321 is configured to cancel out the periodic signal S510 upon passage through the first logic gate P521, such that:
when the oscillator 510 generates the periodic signal S510 and, at the same time, the microcontroller 320 generates the output signal S321, then the control signal S521 generated by the first AND logic gate P521 is a hold signal, which tends to leave the actuator 324 in the closed position once the control signal S521 is received by the second OR logic gate P522 and in the absence of a fault signal S320,
when the microcontroller 320 no longer generates the output signal S320, the control signal S521 is a trigger signal.

In general, schematically, it is understood that if the periodic signal S510 and the output signal S321 are of the same mathematical sign, it is necessary to invert one signal so that, following the first AND logic gate P521, the control signal S521 is a zero signal. More generally, depending on the characteristics of the output signal S321 such as the voltage, the frequency, etc., it is necessary to process this output signal S321 so that it effectively cancels out the periodic signal S510.

In the example illustrated, the output signal S321 is advantageously processed successively by a high-pass filter 523, then by a demodulation circuit 524. In the example illustrated, the output signal is also inverted by a circuit implementing a logic gate P525 of “NOT” type, also referred to as a “NOT” gate, so as to adapt the output signal S321 at the AND logic gate P521 and to cancel out the periodic signal S510 at the AND logic gate P521. The output signal, initially generated by the microcontroller 320 and processed in this way, is referenced S321′.

According to a variant that is not illustrated, the periodic signal S510 is also processed before reaching the first AND logic gate P521. According to another variant that is not illustrated, the output signal and the periodic signal are each processed, by respective electronic circuits, before reaching the first AND logic gate. According to yet another variant, no processing of the output signal is necessary, the microcontroller 320 being configured to directly generate an output signal S320 capable of cancelling out the periodic signal S510.

Advantageously, the microcontroller 320 comprises a reception input P510 for receiving the periodic signal S510 of the oscillator 510, the microcontroller 320 being configured to generate the fault signal S320 when the periodic signal S510 differs from a predetermined nominal periodic signal. Thus, in the same way that the supervision circuit 500 checks that the microcontroller 320 is operating correctly, the microcontroller 320 checks that the oscillator 510 is operating correctly, without this supervision passing through the first AND logic gate P521.

The embodiments and the variants mentioned above may be combined with one another to create new embodiments of the invention.

1. An electrical protection device, configured to electrically connect an electrical load to an electrical power source, the protection device comprising:
at least two incoming terminals, which are configured to be electrically connected to a phase of the power source,
outgoing terminals, which are configured to be connected to the electrical load, each outgoing terminal being associated with a respective incoming terminal,
power supply terminals, which are different from the incoming terminals and which are configured to be connected to a bus supplying operating electrical energy,
electromechanical cut-off means comprising separable contacts, which are movable, by means of an actuator, between a closed position, in which each incoming terminal is electrically connected to the associated outgoing terminal, the protection device being in a closed configuration, and an open position, in which the passage of an electric current between the incoming terminal and the associated outgoing terminal is prevented, the protection device being in an open configuration, the actuator being configured to cause the electromechanical cut-off means to transition from the closed position to the open position when the actuator receives a trigger signal,
detection means, which are configured to measure electrical quantities across the outgoing terminals and to detect at least one electrical fault,
a microcontroller, which is configured to generate a fault signal when the detection means detect a first electrical fault, and
a first power supply unit, which is configured to receive electrical energy from the power supply bus and to supply operating electrical energy to the microcontroller,
wherein:
the actuator is a bistable actuator,
the protection device comprises:
a supervision circuit, which is interposed between the microcontroller and the actuator, the supervision circuit including an oscillator configured to generate a periodic signal, and
a second power supply unit, which is different from the first power supply unit and is configured to receive electrical energy from the power supply bus and to supply electrical energy to the supervision circuit,
the microcontroller is configured to generate an output signal, which is different from the fault signal,
the supervision circuit encompasses:
a first input gate, which is a logic gate configured to receive the output signal of the microcontroller,
a second input gate, which is a logic gate configured to receive the periodic signal of the oscillator,
a third input gate, which is a logic gate configured to receive the fault signal of the microcontroller, and
a main output gate, which is a logic gate connected to the actuator,
the supervision circuit being configured to generate a trigger signal via the main output gate when, alternatively:
the first input gate does not receive the output signal of the microcontroller, or
the second input gate does not receive the periodic signal of the oscillator, or
the third input gate receives a fault signal,
the supervision circuit is configured not to generate the trigger signal via the main output gate as long as, at the same time:
the first input gate receives the output signal of the microcontroller, and
the second input gate receives the periodic signal of the oscillator, and
the third input gate receives no fault signal.

2. The protection device according to claim 1, wherein the supervision circuit comprises:
a first logic circuit, which encompasses the first input gate and the second input gate and implements an AND logic gate, the AND logic gate combining the output signal of the microcontroller with the periodic signal of the oscillator, so as to generate a control signal, and
a second logic circuit, which encompasses the third logic input and the main output gate, the second logic circuit implementing an OR logic gate, the OR logic gate combining the control signal of the AND logic gate with the fault signal of the microcontroller, so as to generate the trigger signal, which is transmitted from the main output gate to the actuator so as to cause the actuator to switch,
wherein:
the output signal is configured to cancel out the periodic signal, such that:
when the oscillator generates the periodic signal and, at the same time, the microcontroller generates the output signal, then the control signal is a hold signal, designed to leave the actuator in the closed position, and
when the microcontroller no longer generates the output signal, the control signal is a trigger signal.

3. The protection device according to claim 1, wherein:
the microcontroller comprises a reception input for receiving the periodic signal of the oscillator, the microcontroller being configured to, when the periodic signal has not detected for a predetermined time interval, generate the fault signal.

4. The protection device according to claim 1, wherein the supervision circuit is realized by a software-free electronic circuit.

5. The protection device according to claim 1, wherein the oscillator is an NE555 integrated circuit or equivalent.

6. A distribution assembly, configured to distribute electrical energy from the power source to at least one electrical load, wherein the distribution assembly comprises a distribution device, which comprises:
a power bus, which comprises a plurality of busbars:
which include at least one phase bar, each phase bar being respectively associated with a phase of the power source(S), and
which extend parallel to each other along a main axis of the distribution device and are aligned along a height axis which is orthogonal to the main axis, and
a power supply bus, which is separate from the power bus, and the distribution assembly also comprises a copy of a protection device, the protection device being mounted on the remainder of the distribution device such that:
each incoming terminal is electrically connected to a corresponding busbar, and
the first power supply unit and the second power supply unit are electrically connected to the power supply bus.

7. The distribution assembly according to claim 6, wherein:
the distribution assembly further includes a main housing, which comprises:
incoming terminals, which are configured to be connected to each phase,
outgoing terminals, which are each connected to the corresponding phase busbar, each outgoing terminal being associated with a respective busbar and with a respective incoming terminal, and
a power supply output, which is connected to the power supply bus, the main housing being configured to provide operating electrical energy to each cut-off device via the power supply bus.

8. The distribution assembly according to claim 7, wherein:
the main housing comprises a general cut-off device, which is configured to, at the same time:
electrically disconnect each outgoing terminal from the corresponding incoming terminal, and
electrically disconnect the power supply output from the power source.

9. The distribution assembly according to claim 8, wherein:
the general cut-off device exhibits monostable switch behaviour.

10. An electrical panel, comprising:
a box, delimiting an enclosure and having a bottom, and
a distribution assembly, configured to distribute electrical energy from a power source to at least one electrical load, wherein the distribution assembly is fixed to the bottom of the housing, wherein the distribution assembly comprises a distribution device,
which comprises:
a power bus, which comprises a plurality of busbars:
which include at least one phase bar, each phase bar being respectively associated with a phase of the power source, and
which extend parallel to each other along a main axis of the distribution device and are aligned along a height axis which is orthogonal to the main axis, and
a power supply bus, which is separate from the power bus, and
the distribution assembly also comprises a copy of a protection device, the protection device being mounted on the remainder of the distribution device such that:
each incoming terminal is electrically connected to a corresponding busbar, and
the first power supply unit and the second power supply unit are electrically connected to the power supply bus.

11. The protection device according to claim 1, wherein the incoming terminals are further configured to be electrically connected to a neutral of the power source.

12. The protection device according to claim 1, wherein the operating electrical energy comes from the power source.

13. The distribution assembly according to claim 6, wherein the plurality of busbars comprises one neutral bar, the neutral bar being associated with a neutral of the power source.

14. The distribution assembly according to claim 7, wherein the incoming terminals are further configured to be connected to a neutral of the power source.

15. The distribution assembly according to claim 7, wherein one of the outgoing terminals is connected to a corresponding neutral bar of the plurality of busbars, the neutral bar being associated with a neutral of the power source.

16. The electrical panel according to claim 10, wherein the plurality of busbars comprises one neutral bar, the neutral bar being associated with a neutral of the power source.
